(19) United States
(12) Patent Application Publication
(10) Pub. No.: US 2026/0352478 A1
(43) Pub. Date: Nov. 5, 2026

(54) TEE-BASED SMART HOME REMOTE CONTROL METHOD AND RELATED APPARATUS

(71) Applicants: GUIZHOU POWER GRID CO., LTD., Guiyang, Guizhou (CN); ELECTRIC POWER RESEARCH INSTITUTE. CHINA SOUTHERN POWER GRID, Guangzhou, Guangdong (CN)

(72) Inventors: Houpeng HU, Guiyang, Guizhou (CN); Yi LUO, Guangzhou, Guangdong (CN); Zhenghao GAO, Guiyang, Guizhou (CN); Bin QIAN, Guangzhou, Guangdong (CN); Jiaxiang OU, Guangzhou, Guangdong (CN); Mi ZHOU, Guangzhou, Guangdong (CN)

(73) Assignees: GUIZHOU POWER GRID CO., LTD., Guiyang, Guizhou (CN); ELECTRIC POWER RESEARCH INSTITUTE. CHINA SOUTHERN POWER GRID, Guangzhou, Guangdong (CN)

(21) Appl. No.: 19/104,676

(22) PCT Filed: Jun. 9, 2023
(86) PCT No.: PCT/CN2023/099350

§ 371 Date: Dec. 14, 2025

(30) Foreign Application Priority Data
Sep. 20, 2022 (CN) 202211144330.9

(51) Int. Cl. H04L 9/32; G05B 15/02; H04L 9/08

(52) U.S. Cl. CPC H04L 9/3226; G05B 15/02; H04L 9/085; H04L 9/0866; H04L 9/3297

(57) ABSTRACT

A TEE-based smart home remote control method and a related apparatus, which relate to the technical field of smart homes. The method comprises: when a TEE is enabled, performing a user legitimacy check by means of a user terminal and according to preset login information and login information which is stored in the TEE; if the user legitimacy check is passed, sending to a remote sensor a randomly generated timestamp and identity verification information by means of the user terminal; respectively performing, by means of the remote sensor, replay attack verification and identity legitimacy verification according to the timestamp and the identity verification information, and if the two instances of verification are passed, generating a first shared key, and sending verification success information to the user terminal; and after the verification success information is received, generating a second shared key by means of the user terminal, and performing instruction interaction control with the remote sensor on the basis of the first shared key and the second shared key. The present application solves the technical problem whereby existing smart home remote control technology cannot meet the requirements for both attack resistance and high efficiency.

The present application claims priority to Chinese Patent Application No. 202211144330.9, titled “TEE-BASED SMART HOME REMOTE CONTROL METHOD AND RELATED APPARATUS”, filed on Sep. 20, 2022 with the China National Intellectual Property Administration, which is incorporated herein by reference in its entirety.

### FIELD

The present disclosure relates to the technical field of smart homes, and in particular to a TEE-based remote control method and related apparatus for a smart home.

### BACKGROUND

With updating of the social-economic system, improvement of the information technology and rapid development of Internet of Things, people put forward higher requirements for home environments. An increasing number of families seek intelligence of home environments, as well as put forward higher requirements for security of home environments. Remote control of a smart home by people is implemented by receiving various sensor signals via various sensing devices and triggering control commands. In recent years, remote-controlled smart home attracts widespread attention and praise for its convenience. Multiple solutions for smart home remote control exist. With the development of technology, stricter security and efficiency requirements are put forward for solutions for smart home remote control.

The solutions for smart home remote control generally require to possess operability feasibility, man-in-the-middle attack resistance, replay-attack resistance, and efficiency. The requirements for the conventional technology for smart home remote control increase continually. The conventional technology meets some requirements while sacrificing some requirements simultaneously, causing that the remote control process for the smart home fails to simultaneously ensure the attack resistance and the high efficiency.

### SUMMARY

According to the present disclosure, a TEE-based remote control method and related apparatus for a smart home are provided, to solve the technical problem that the conventional technology for smart home remote control fails to simultaneously meet the requirements of attack resistance and high efficiency.

In view of the above, in a first aspect of the present disclosure, a TEE-based remote control method for a smart home is provided. The TEE-based remote control method for the smart home includes:
performing user authorization verification via a user terminal based on preset login information and TEE stored login information in a case that a TEE in a TrustZone architecture is enabled;
sending, if the user authorization verification passes, a randomly generated timestamp and identity verification information to a remote sensor via the user terminal, where the identity verification information includes a time verification hash value and a matched pseudo-identity ID;
performing replay attack verification via the remote sensor based on the timestamp and performing identity authorization verification via the remote sensor based on the identity verification information, generating a first shared key and sending verification success information to the user terminal if both the replay attack verification and the identity authorization verification pass; and
generating a second shared key via the user terminal in a case that the verification success information is received, and performing instruction interaction with the remote sensor based on the first shared key and the second shared key to implement remote control of a smart home device.

In an embodiment, before the performing user authorization verification via a user terminal based on preset login information and TEE stored login information in a case that a TEE in a TrustZone architecture is enabled, the TEE-based remote control method for the smart home further includes:
registering user information on the remote sensor via the user terminal in the case that the TEE in the TrustZone architecture is enabled, where the user information includes a user ID and a user password;
generating a registered pseudo-identity ID, an identity hash verification value and the matched pseudo-identity ID via the remote sensor based on a master key and the user information by using a hash algorithm; and
storing the registered pseudo-identity ID, the identity hash verification value and the matched pseudo-identity ID in a TEE system via the remote sensor to form the TEE stored login information, and sending the TEE stored login information to the user terminal to complete user registration.

In an embodiment, the performing user authorization verification via a user terminal based on preset login information and TEE stored login information in a case that a TEE in a TrustZone architecture is enabled includes:
sending the preset login information to the remote sensor via the user terminal in the case that the TEE in the TrustZone architecture is enabled, where the preset login information includes a current user ID and a current user password;
calculating a current identity hash value via the remote sensor based on the preset login information and the registered pseudo-identity ID in the TEE stored login information; and
performing the user authorization verification by comparing the current identity hash value with the identity hash verification value in the TEE stored login information, and determining that the user authorization verification passes if the comparison result indicates that the current identity hash value is consistent with the identity hash verification value.

In an embodiment, the performing replay attack verification via the remote sensor based on the timestamp and performing identity authorization verification via the remote sensor based on the identity verification information, generating a first shared key and sending verification success information to the user terminal, if both the replay attack verification and the identity authorization verification pass, includes:
performing the replay attack verification via the remote sensor based on the timestamp and a time threshold range;
searching for a registered pseudo-identity ID corresponding to the matched pseudo-identity ID if the replay attack verification passes;
calculating a current time hash value based on the searched registered pseudo-identity ID and the timestamp, comparing the current time hash value with the time verification hash value, and determining that the identity authorization verification passes if the comparison result indicates that the current time hash value is consistent with the time verification hash value; and
generating the first shared key with the user terminal via the remote sensor and sending the verification success information to the user terminal, if the identity authorization verification passes.

In a second aspect of the present disclosure, a TEE-based remote control apparatus for a smart home is provided. The TEE-based remote control apparatus for the smart home includes a login verification module, an information sending module, a user verification module and a session control module.

The login verification module is configured to perform user authorization verification via a user terminal based on preset login information and TEE stored login information in a case that a TEE in a TrustZone architecture is enabled.

The information sending module is configured to send, if the user authorization verification passes, a randomly generated timestamp and identity verification information to a remote sensor via the user terminal, where the identity verification information includes a time verification hash value and a matched pseudo-identity ID.

The user verification module is configured to perform replay attack verification via the remote sensor based on the timestamp and perform identity authorization verification via the remote sensor based on the identity verification information, generate a first shared key, and send verification success information to the user terminal, if both the replay attack verification and the identity authorization verification pass.

The session control module is configured to generate a second shared key via the user terminal in a case that the verification success information is received, and perform instruction interaction with the remote sensor based on the first shared key and the second shared key to implement remote control of a smart home device.

In an embodiment, the TEE-based remote control apparatus for the smart home further includes a registration module, a calculation module and a storage module.

The registration module is configured to register user information on the remote sensor via the user terminal in the case that the TEE in the TrustZone architecture is enabled, and the user information includes a user ID and a user password.

The calculation module is configured to generate a registered pseudo-identity ID, an identity hash verification value and the matched pseudo-identity ID via the remote sensor based on a master key and the user information by using a hash algorithm.

The storage module is configured to store the registered pseudo-identity ID, the identity hash verification value and the matched pseudo-identity ID in a TEE system via the remote sensor to form the TEE stored login information, and send the TEE stored login information to the user terminal to complete user registration.

In an embodiment, the login verification module is further configured to:
send the preset login information to the remote sensor via the user terminal in the case that the TEE in the TrustZone architecture is enabled, where the preset login information includes a current user ID and a current user password;
calculate a current identity hash value via the remote sensor based on the preset login information and the registered pseudo-identity ID in the TEE stored login information; and
perform the user authorization verification by comparing the current identity hash value with the identity hash verification value in the TEE stored login information, and determine that the user authorization verification passes if the comparison result indicates that the current identity hash value is consistent with the identity hash verification value.

In an embodiment, the user verification module is further configured to:
perform the replay attack verification via the remote sensor based on the timestamp and a time threshold range;
search for a registered pseudo-identity ID corresponding to the matched pseudo-identity ID if the replay attack verification passes;
calculate a current time hash value based on the searched registered pseudo-identity ID and the timestamp, compare the current time hash value with the time verification hash value, and determine that the identity authorization verification passes if the comparison result indicates that the current time hash value is consistent with the time verification hash value; and
generate the first shared key with the user terminal via the remote sensor and send the verification success information to the user terminal, if the identity authorization verification passes.

In a third aspect of the present disclosure, a TEE-based remote control device for a smart home is provided. The TEE-based remote control device for the smart home includes a processor and a memory.

The memory is configured to store program codes and transmit the program codes to the processor.

The processor is configured to perform the TEE-based remote control method for the smart home described in the first aspect according to instructions in the program codes.

In a fourth aspect of the present disclosure, a computer-readable storage medium is provided. The computer-readable storage medium stores program codes. The program codes are used to perform the TEE-based remote control method for the smart home described in the first aspect.

It can be seen from the above technical solutions that the embodiments of the present disclosure have the following advantages.

According to the present disclosure, a TEE-based remote control method for a smart home is provided, including: performing user authorization verification via a user terminal based on preset login information and TEE stored login information in a case that a TEE in a TrustZone architecture is enabled; sending, if the user authorization verification passes, a randomly generated timestamp and identity verification information to a remote sensor via the user terminal, where the identity verification information includes a time verification hash value and a matched pseudo-identity ID; performing replay attack verification via the remote sensor based on the timestamp and performing identity authorization verification via the remote sensor based on the identity verification information, generating a first shared key, and sending verification success information to the user terminal if both the replay attack verification and the identity authorization verification pass; and generating a second shared key via the user terminal in a case that the verification success information is received, and performing instruction interaction with the remote sensor based on the first shared key and the second shared key to implement remote control of a smart home device.

In the TEE-based remote control method for the smart home according to the present disclosure, the user identity authorization verification is performed through user login information, so as to ensure that the controller is verified to be a legitimate user before communication, thus meeting the requirement of verifiability. The replay attack verification and identity authorization verification are performed based on the timestamp and identity verification information generated by the user, resisting replay attacks, thereby avoiding waste of system resource, and resisting user impersonation attacks, thereby avoiding illegal activities. Moreover, the entire technical solution is performed in the TEE environment, preventing the information from being attacked or intercepted during the transmission and storage process, thereby ensuring the security of the data. In addition, the process is performed without using additional encryption algorithms or operational methods, which is implemented easily and of high efficiency. Therefore, the technical problem that the conventional technology for smart home remote control fails to meet the requirements of the attack resistance and the high efficiency simultaneously is solved according to the present disclosure.

### BRIEF DESCRIPTION OF THE DRAWINGS

FIG. 1 is a flowchart of a TEE-based remote control method for a smart home according to an embodiment of the present disclosure;

FIG. 2 is a schematic structural diagram of a TEE-based remote control apparatus for a smart home according to an embodiment of the present disclosure;

FIG. 3 is a schematic diagram of remote control of a smart home based on TEE according to an embodiment of the present disclosure; and

FIG. 4 is a schematic diagram of TrustZone architectures of different Cortexes according to an embodiment of the present disclosure.

### DETAILED DESCRIPTION OF THE EMBODIMENTS

In order to enable those skilled in the art to better understand the technical solution according to the present disclosure, the technical solutions according to the embodiments of the present disclosure will be described clearly and completely hereinafter with reference to the accompanying drawings in the embodiments of the present disclosure. Apparently, the described embodiments are only part of the embodiments according to the present disclosure, rather than all of the embodiments. Based on the embodiments of the present disclosure, all other embodiments obtained by those skilled in the art without any creative work fall into the protection scope of the present disclosure.

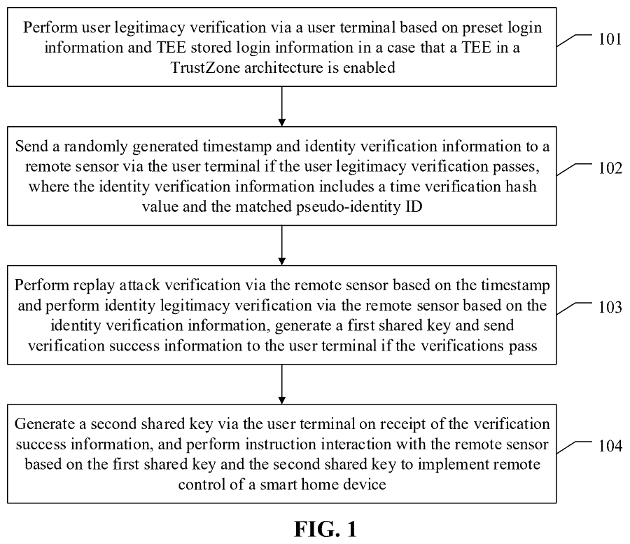

To facilitate understanding, reference is made to FIG. 1. In an embodiment of the present disclosure, a TEE-based remote control method for a smart home includes the following steps 101 to 104.

In step 101, user authorization verification is performed via a user terminal based on preset login information and TEE stored login information in a case that a TEE in a TrustZone architecture is enabled.

Further, the step 101 includes:
sending the preset login information to a remote sensor via the user terminal in the case that the TEE in the TrustZone architecture is enabled, where the preset login information includes a current user ID and a current user password;
calculating a current identity hash value via the remote sensor based on the preset login information and the registered pseudo-identity ID in the TEE stored login information; and
performing the user authorization verification by comparing the current identity hash value with the identity hash verification value in the TEE stored login information, and determining that the verification passes if the comparison result indicates that the current identity hash value is consistent with the identity hash verification value.

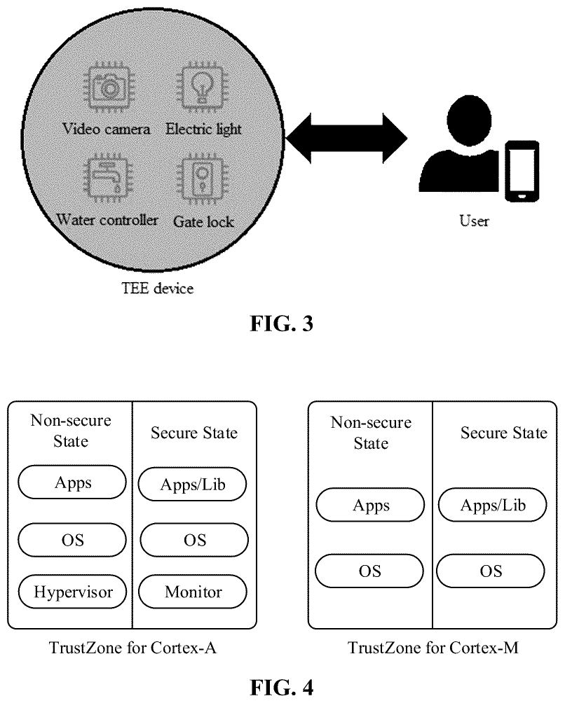

A TEE-based remote control system for a smart home may be described as shown in FIG. 3. A Cortex processor is integrated in a remote sensor and a user terminal, such as a smartphone, and a TrustZone architecture is deployed. The TrustZone architecture isolates a secure world through hardware and provides a TEE system. The confidential data of the user terminal is stored in the TEE constructed based on the TrustZone, a hacker cannot obtain the confidential data even if the hacker completely controls an operating system in a rich execution environment (REE). The Cortex-A processors are different, and the deployed TrustZone architectures are different. Reference is made to FIG. 4, which is a schematic diagram of TrustZone architectures based on Cortex-A and Cortex-M.

The TEE in the TrustZone architecture is enabled before establishing the session or communication, and a session is initiated. The user terminal may request to login based on the preset login information. That is, the user terminal requests the remote sensor to perform user identity authorization verification. The verification process by the remote sensor is based on the preset login information, and implemented by performing hash calculation and numerical comparison based on the TEE stored login information. The information stored in the TEE system cannot be obtained by an external attack target, significantly ensuring the security and reliability of the verification process.

It should be noted that the registered pseudo-identity ID and the identity hash verification value in the TEE stored login information are stored in the TEE system by user during the registration stage, and can be directly extracted for calculation and comparison verification. The comparison verification being consistent indicates that the user authorization verification passes. Otherwise, the user authorization verification fails, it is determined that the user terminal is an illegal identity, and the operation is terminated. In a case that IDi represents a current user ID, PWi represents a current user password, and UIDi represents the registered pseudo-identity ID, the current identity hash value can be calculated by V′=h (IDi∥PWi∥UIDi), and the identity hash verification value may be represented by V. If V′ is consistent with V, the user authorization verification passes.

Further, before step 101, the TEE-based remote control method for the smart home further includes:
registering user information on the remote sensor via the user terminal in the case that the TEE in the TrustZone architecture is enabled, where the user information includes a user ID and a user password;
generating a registered pseudo-identity ID, an identity hash verification value and the matched pseudo-identity ID via the remote sensor based on a master key and the user information by using a hash algorithm; and
storing the registered pseudo-identity ID, the identity hash verification value and the matched pseudo-identity ID in a TEE system via the remote sensor to form the TEE stored login information, and sending the TEE stored login information to the user terminal to complete user registration.

The user terminal requires to perform the user identity registration before performing interaction authentication with the remote sensor. In addition to receiving the registered user information sent by the user terminal, the remote sensor performs operations including calculation, information storage, information transmission and the like. The registered pseudo-identity ID, i.e., UIDi, is obtained by performing hash calculation based on the master key and user ID in the remote sensor. The matched pseudo-identity ID, represented by the RIDi, is information matching with the registered pseudo-identity ID and generated based on the user ID. The identity hash verification value V is obtained by performing the hash calculation based on the user ID, user password and registered pseudo-identity ID, and is expressed as V=h(IDi∥PWi∥UIDi).

The generated registered pseudo-identity ID, the identity hash verification value, and the matched pseudo-identity ID are further sent to the user terminal to complete the user registration process in addition to being stored in the TEE system to form the TEE stored login information.

In step 102, if the user authorization verification passes, a randomly generated timestamp and identity verification information are sent to the remote sensor via the user terminal. The identity verification information includes a time verification hash value and the matched pseudo-identity ID.

A session key establishment stage may be performed if the user authorization verification passes. The timestamp randomly generated by the user terminal generates a time verification hash value through the hash calculation to participate in subsequent key negotiation verification. The matched pseudo-identity ID received by the user terminal from the remote sensor is sent to the remote sensor together with the timestamp and the time verification hash value, to verify that the user terminal receives the information sent by the remote sensor and the received information is correct, that is, the information is not been tampered with or replaced. In a case that the timestamp is represented by T1, the time verification hash value generated based on the timestamp is expressed as A1=h(UIDi∥T1), that is, the time verification hash value is calculated based on the timestamp and the registered pseudo-identity ID. Further, the timestamp T1, the time verification hash value A1 and the matched pseudo-identity ID, that is, the RIDi, are sent to the remote sensor together.

In step 103, replay attack verification is performed via the remote sensor based on the timestamp and identity authorization verification is performed via the remote sensor based on the identity verification information, a first shared key is generated and verification success information is sent to the user terminal if both the replay attack verification and the identity authorization verification pass.

Further, step 103 includes:
performing the replay attack verification via the remote sensor based on the timestamp and a time threshold range;
searching for a registered pseudo-identity ID corresponding to the matched pseudo-identity ID if the replay attack verification passes;
calculating a current time hash value based on the searched registered pseudo-identity ID and the timestamp, comparing the current time hash value with the time verification hash value, and determining that the identity authorization verification passes if the comparison result indicates that the current time hash value is consistent with the time verification hash value; and
generating the first shared key with the user terminal via the remote sensor and sending the verification success information to the user terminal, if the identity authorization verification passes.

The verification process by the remote sensor mainly includes two parts: the replay attack verification based on the timestamp, and the identity authorization verification based on the identity verification information. In a case that both the verification processes pass, it is determined that the verification succeeds, a shared key of the two interaction terminals is generated and the verification success information is sent.

In an embodiment, the replay attack verification process is determined based on the timestamp T1 and the time threshold range. That is, the replay attack verification process is implemented by calculating the difference between a preset reference value Tc and the timestamp T1. If the value of Tc−T1 falls within the time threshold range, it is indicated that it has not been subject to a replay attack and the replay attack verification passes. Otherwise, the sensor stops operating. It can be understood that the time threshold range and the preset reference value are set according to the actual situation and are not limited herein.

The identity authorization verification process is performed after the replay attack verification passes. The registered pseudo-identity ID corresponding to the matched pseudo-identity ID in the identity verification information is searched in the TEE system. The current time hash value A1′=h(UIDi∥T1) is calculated based on the searched registered pseudo-identity ID and the timestamp T1. A1′ is compared with the time verification hash value A1. If the A1′ is consistent with the time verification hash value A1, it is indicated that the user terminal is legal, that is, the identity authorization verification passes. Otherwise, the operation is terminated.

It should be noted that the shared key is used for interaction between the user terminal and the remote sensor. The remote sensor directly generates the first shared key after verification passes, and simultaneously sends the verification success information to the user terminal. In this case, the remote sensor completes a task of establishing the session.

In step 104, a second shared key is generated via the user terminal on receipt of the verification success information, and instruction interaction is performed with the remote sensor based on the first shared key and the second shared key to implement remote control of a smart home device.

The user terminal may generates a second shared key upon receiving the verification success information, completing the task of establishing the session. Therefore, the user terminal can communicate with the remote sensor through the first shared key and the second shared key, that is, controlling instruction interaction, thereby implement remote control of the smart home device. The first shared key and the second shared key, which have the same property and match with each other, are interaction keys between the user terminal and the remote sensor and can perform flexible encryption and decryption operations. Since key negotiation between the user terminal and the remote sensor is performed in the TEE environment and the key negotiation important information is stored in the TEE system, the shared key can resist various attacks, thus preventing a third party from obtaining the secret information and intercepting or tampering with the information through attacking one party, thereby ensuring the security and reliability of the key interaction process.

In order to verify the high efficiency of the technical solution provided according to the present disclosure, a specific comparison case is provided according to the present disclosure. The comparison object is a remote control solution for smart home in the conventional technology. The specific comparison result is shown in Table 1 and Table 2.

TABLE 1
Comparison of time efficiencies of the two solutions

| | User | Session key |
|---|---|---|
| | registration | establishment |
| Solution | stage | stage |
| Solution of the present disclosure | 2/h | 3/h |
| Solution of the conventional technology | 6/h | 31/h |

TABLE 2
Comparison of communication efficiencies
between the two solutions

| | User | Session key |
|---|---|---|
| | registration | establishment |
| Solution | stage | stage |
| Solution of the present disclosure | 2Messges | 2Messges |
| Solution of the conventional technology | 2Messges | 6Messges |

It can be known from Table 1 and Table 2 that, the technical solution of the present disclosure has significant advantages in time efficiency, and has significant advantages in communication efficiency during the session key establishment stage, and is more preferable than the technical solution in the conventional technology, ensuring both security and high efficiency.

In the TEE-based remote control method for the smart home according to the embodiments of the present disclosure, the user identity authorization verification is performed through user login information, so as to ensure that the controller is verified to be a legitimate user before communication, thus meeting the requirement of verifiability. The replay attack verification and identity authorization verification are performed based on the timestamp and identity verification information generated by the user, resisting replay attacks, thereby avoiding waste of system resource, and resisting user impersonation attacks, thereby avoiding illegal activities. Moreover, the entire technical solution is performed in the TEE environment, preventing the information from being attacked or intercepted during the transmission and storage process, thereby ensuring the security of the data. In addition, the process is performed without using additional encryption algorithms or operational methods, which is implemented easily and of high efficiency. Therefore, the technical problem that the conventional technology for smart home remote control fails to meet the requirements of the attack resistance and the high efficiency simultaneously is solved according to the present disclosure.

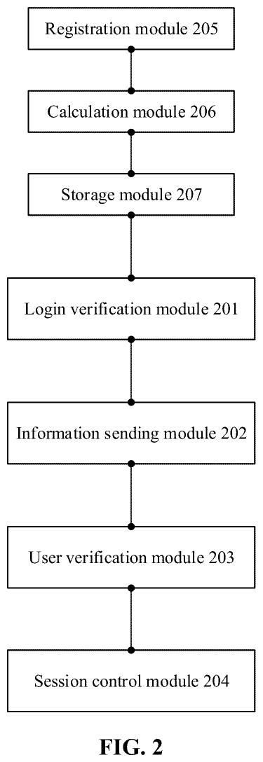

To facilitate understanding, reference is made to FIG. 2. A TEE-based remote control apparatus for a smart home is provided according to an embodiment of the present disclosure. The TEE-based remote control apparatus for the smart home includes a login verification module 201, an information sending module 202, a user verification module 203 and a session control module 204.

The login verification module 201 is configured to perform user authorization verification via a user terminal based on preset login information and TEE stored login information in a case that a TEE in a TrustZone architecture is enabled.

The information sending module 202 is configured to send, if the user authorization verification passes, a randomly generated timestamp and identity verification information to a remote sensor via the user terminal, where the identity verification information includes a time verification hash value and a matched pseudo-identity ID.

The user verification module 203 is configured to perform replay attack verification via the remote sensor based on the timestamp and perform identity authorization verification via the remote sensor based on the identity verification information, generate a first shared key, and send verification success information to the user terminal, if both the replay attack verification and the identity authorization verification pass.

The session control module 204 is configured to generate a second shared key via the user terminal in a case that the verification success information is received, and perform instruction interaction with the remote sensor based on the first shared key and the second shared key to implement remote control of a smart home device.

Moreover, the TEE-based remote control apparatus for the smart home further includes a registration module 205, a calculation module 206 and a storage module 207.

The registration module 205 is configured to register user information on the remote sensor via the user terminal in the case that the TEE in the TrustZone architecture is enabled, and the user information includes a user ID and a user password.

The calculation module 206 is configured to generate a registered pseudo-identity ID, an identity hash verification value and the matched pseudo-identity ID via the remote sensor based on a master key and the user information by using a hash algorithm.

The storage module 207 is configured to store the registered pseudo-identity ID, the identity hash verification value and the matched pseudo-identity ID in a TEE system via the remote sensor to form the TEE stored login information, and send the TEE stored login information to the user terminal to complete user registration.

In an embodiment, the login verification module 201 is further configured to:
send the preset login information to the remote sensor via the user terminal in the case that the TEE in the TrustZone architecture is enabled, where the preset login information includes a current user ID and a current user password;
calculate a current identity hash value via the remote sensor based on the preset login information and the registered pseudo-identity ID in the TEE stored login information; and
perform the user authorization verification by comparing the current identity hash value with the identity hash verification value in the TEE stored login information, and determine that the user authorization verification passes if the comparison result indicates that the current identity hash value is consistent with the identity hash verification value.

In an embodiment, the user verification module 203 is further configured to:
perform the replay attack verification via the remote sensor based on the timestamp and a time threshold range;
search for a registered pseudo-identity ID corresponding to the matched pseudo-identity ID if the replay attack verification passes;
calculate a current time hash value based on the searched registered pseudo-identity ID and the timestamp, compare the current time hash value with the time verification hash value, and determine that the identity authorization verification passes if the comparison result indicates that current time hash value is consistent with the time verification hash value; and
generate the first shared key with the user terminal via the remote sensor and send the verification success information to the user terminal, if the identity authorization verification passes.

A TEE-based remote control device for a smart home is further provided according to the present disclosure. The TEE-based remote control device for the smart home includes a processor and a memory.

The memory is configured to store program codes and transmit the program codes to the processor.

The processor is configured to perform TEE-based remote control method for the smart home described in the above embodiments according to instructions in the program codes.

A computer-readable storage medium is provided according to the present disclosure. The computer-readable storage medium is configured to store program codes. The program codes are used to perform the TEE-based remote control method for the smart home described in the above method embodiments.

It should be understood that the apparatus and method disclosed in the embodiments of the present disclosure may be implemented in other manners. For example, the apparatus embodiments described above are only schematic. For example, the division of the units is only a division according to logical functions, and there may be other division manners in practical implementations. For example, multiple units or components may be combined or may be integrated into another system, or some features may be omitted or may be not implemented. In addition, the mutual coupling or direct coupling or communication connection shown or discussed above may be indirect coupling or communication connection via some interfaces, devices or units, and may be electrical, mechanical or in other forms.

The units described as separate components may be or may not be separated physically, and the components displayed as units may be or may not be physical units. That is, the components may be located at a same position, or may be distributed to multiple network units. Some or all of the units may be selected according to actual requirements to achieve the objective of the solutions of the embodiments.

In addition, functional units in the embodiments of the present disclosure may be integrated in one processing unit, or each unit may be physically independent, or two or more units may be integrated in one unit. The integrated unit may be implemented in a form of hardware, or in a form of a software function unit.

In a case that the integrated unit is implemented in the form of software function unit and is sold or used as a separate product, it can also be stored in a computer readable storage medium. Based on such an understanding, the technical solutions of the present disclosure essentially, or the part contributing to the conventional technology, or all or a part of the technical solutions may be implemented in the form of a software product. The computer software product is stored in a storage medium and includes various instructions for instructing a computer device (which may be a personal computer, a server or a network device) to perform all or some of the steps of the method described in the embodiments of the present disclosure. The foregoing storage medium includes various media that can store program codes such as a USB disk, a mobile hard disk, a read-only memory (ROM), a random access memory (RAM), a magnetic disk, or an optical disk.

The foregoing embodiments are used for describing, instead of limiting the technical solutions of the present disclosure. Those skilled in the art shall understand that although the present disclosure has been described in detail with reference to the foregoing embodiments, modifications can be made to the technical solutions described in the foregoing embodiments, or equivalent replacements may be made to some technical features in the technical solutions, provided that such modifications or replacements do not cause the essence of corresponding technical solutions to depart from the spirit and scope of the technical solutions of the embodiments of the present disclosure.

1. A TEE-based remote control method for a smart home, comprising:
performing user authorization verification via a user terminal based on preset login information and TEE stored login information in a case that a TEE in a TrustZone architecture is enabled;
sending, if the user authorization verification passes, a randomly generated timestamp and identity verification information to a remote sensor via the user terminal, wherein the identity verification information comprises a time verification hash value and a matched pseudo-identity ID;
performing replay attack verification via the remote sensor based on the timestamp and performing identity authorization verification via the remote sensor based on the identity verification information, and generating a first shared key and sending verification success information to the user terminal if both the replay attack verification and the identity authorization verification pass; and
generating a second shared key via the user terminal in a case that the verification success information is received, and performing instruction interaction with the remote sensor based on the first shared key and the second shared key to implement remote control of a smart home device.

2. The TEE-based remote control method for the smart home according to claim 1, wherein before the performing user authorization verification via a user terminal based on preset login information and TEE stored login information in a case that a TEE in a TrustZone architecture is enabled, the TEE-based remote control method for the smart home further comprises:
registering user information on the remote sensor via the user terminal in the case that the TEE in the TrustZone architecture is enabled, wherein the user information comprises a user ID and a user password;
generating a registered pseudo-identity ID, an identity hash verification value and the matched pseudo-identity ID via the remote sensor based on a master key and the user information by using a hash algorithm; and
storing the registered pseudo-identity ID, the identity hash verification value and the matched pseudo-identity ID in a TEE system via the remote sensor to form the TEE stored login information, and sending the TEE stored login information to the user terminal to complete user registration.

3. The TEE-based remote control method for the smart home according to claim 2, wherein the performing user authorization verification via a user terminal based on preset login information and TEE stored login information in a case that a TEE in a TrustZone architecture is enabled comprises:
sending the preset login information to the remote sensor via the user terminal in the case that the TEE in the TrustZone architecture is enabled, wherein the preset login information comprises a current user ID and a current user password;
calculating a current identity hash value via the remote sensor based on the preset login information and the registered pseudo-identity ID in the TEE stored login information; and
performing the user authorization verification by comparing the current identity hash value with the identity hash verification value in the TEE stored login information, and determining that the user authorization verification passes if the comparison result indicates that the current identity hash value is consistent with the identity hash verification value.

4. The TEE-based remote control method for the smart home according to claim 1, wherein the performing replay attack verification via the remote sensor based on the timestamp and performing identity authorization verification via the remote sensor based on the identity verification information, generating a first shared key, and sending verification success information to the user terminal, if both the replay attack verification and the identity authorization verification pass, comprises:
performing the replay attack verification via the remote sensor based on the timestamp and a time threshold range;
searching for a registered pseudo-identity ID corresponding to the matched pseudo-identity ID if the replay attack verification passes;
calculating a current time hash value based on the searched registered pseudo-identity ID and the timestamp, comparing the current time hash value with the time verification hash value, and determining that the identity authorization verification passes if the comparison result indicates that the current time hash value is consistent with the time verification hash value; and
generating the first shared key with the user terminal via the remote sensor and sending the verification success information to the user terminal, if the identity authorization verification passes.

5. A TEE-based remote control apparatus for a smart home, comprising:
a login verification module, configured to perform user authorization verification via a user terminal based on preset login information and TEE stored login information in a case that a TEE in a TrustZone architecture is enabled;
an information sending module, configured to send, if the user authorization verification passes, a randomly generated timestamp and identity verification information to a remote sensor via the user terminal, wherein the identity verification information comprises a time verification hash value and a matched pseudo-identity ID;
a user verification module, configured to perform replay attack verification via the remote sensor based on the timestamp and perform identity authorization verification via the remote sensor based on the identity verification information, generate a first shared key, and send verification success information to the user terminal, if both the replay attack verification and the identity authorization verification pass; and
a session control module, configured to generate a second shared key via the user terminal in a case that the verification success information is received, and perform instruction interaction with the remote sensor based on the first shared key and the second shared key to implement remote control of a smart home device.

6. The TEE-based remote control apparatus for the smart home according to claim 5, further comprising:
a registration module, configured to register user information on the remote sensor via the user terminal in the case that the TEE in the TrustZone architecture is enabled, wherein the user information comprises a user ID and a user password;
a calculation module, configured to generate a registered pseudo-identity ID, an identity hash verification value and the matched pseudo-identity ID via the remote sensor based on a master key and the user information by using a hash algorithm; and
a storage module, configured to store the registered pseudo-identity ID, the identity hash verification value and the matched pseudo-identity ID in a TEE system via the remote sensor to form the TEE stored login information, and send the TEE stored login information to the user terminal to complete user registration.

7. The TEE-based remote control apparatus for the smart home according to claim 6, wherein the login verification module is further configured to:
send the preset login information to the remote sensor via the user terminal in the case that the TEE in the TrustZone architecture is enabled, wherein the preset login information comprises a current user ID and a current user password;
calculate a current identity hash value via the remote sensor based on the preset login information and the registered pseudo-identity ID in the TEE stored login information; and
perform the user authorization verification by comparing the current identity hash value with the identity hash verification value in the TEE stored login information, and determine that the user authorization verification passes if the comparison result indicates that the current identity hash value is consistent with the identity hash verification value.

8. The TEE-based remote control apparatus for the smart home according to claim 5, wherein the user verification module is further configured to:
perform the replay attack verification via the remote sensor based on the timestamp and a time threshold range;
search for a registered pseudo-identity ID corresponding to the matched pseudo-identity ID if the replay attack verification passes;
calculate a current time hash value based on the searched registered pseudo-identity ID and the timestamp, compare the current time hash value with the time verification hash value, and determine that the identity authorization verification passes if the comparison result indicates that the current time hash value is consistent with the time verification hash value; and
generate the first shared key with the user terminal via the remote sensor and send the verification success information to the user terminal, if the identity authorization verification passes.

9. A TEE-based remote control device for a smart home, comprising a processor, and a memory, wherein
the memory is configured to store program codes and transmit the program codes to the processor; and
the processor is configured to perform the TEE-based remote control method for the smart home according to claim 1 based on instructions in the program codes.

10. A computer-readable storage medium, storing program codes, wherein
the program codes are used to perform the TEE-based remote control method for the smart home according to claim 1.

11. A TEE-based remote control device for a smart home, comprising a processor, and a memory, wherein
the memory is configured to store program codes and transmit the program codes to the processor; and
the processor is configured to perform the TEE-based remote control method for the smart home according to claim 2 based on instructions in the program codes.

12. A TEE-based remote control device for a smart home, comprising a processor, and a memory, wherein
the memory is configured to store program codes and transmit the program codes to the processor; and
the processor is configured to perform the TEE-based remote control method for the smart home according to claim 3 based on instructions in the program codes.

13. A TEE-based remote control device for a smart home, comprising a processor, and a memory, wherein
the memory is configured to store program codes and transmit the program codes to the processor; and
the processor is configured to perform the TEE-based remote control method for the smart home according to claim 4 based on instructions in the program codes.
